(19) United States
(12) Patent Application Publication
(10) Pub. No.: US 2024/0297420 A1
(43) Pub. Date: Sep. 5, 2024

(54) BONDING METHOD AND POWER STORAGE DEVICE

(71) Applicant: Komatsu Ltd., Tokyo (JP)

(72) Inventors: Kenichi Noto, Tokyo (JP); Ryo Kawai, Tokyo (JP); Shimon Morikawa, Tokyo (JP); Ryota Kasama, Tokyo (JP); Hiroyuki Mizukami, Tokyo (JP); Yasuhiko Matsuki, Tokyo (JP)

(73) Assignee: Komatsu Ltd., Tokyo (JP)

(21) Appl. No.: 18/289,911

(22) PCT Filed: Jun. 2, 2022
(86) PCT No.: PCT/JP2022/022488

§ 371 Date: Nov. 8, 2023

(30) Foreign Application Priority Data
Jun. 10, 2021 (JP) 2021-097397

(51) Int. Cl. H01M 50/536; H01G 11/06; H01G 11/86; H01M 10/0525; H01M 10/0585

(52) U.S. Cl. CPC H01M 50/536; H01G 11/06; H01G 11/86; H01M 10/0525; H01M 10/0585

(57) ABSTRACT

A bonding method includes a step of alternately stacking an electrode foil and a separator and forming a protruding portion extending to extend the stacked electrode foil, and a step of wobbling welding the protruding portion and a collector plate by irradiating an outer surface of the collector plate with laser light in a state in which an inner surface of the collector plate is in contact with the protruding portion.

### TECHNICAL FIELD

The present disclosure relates to a bonding method and a power storage device. Priority is claimed on Japanese Patent Application No. 2021-097397, filed on Jun. 10, 2021, the content of which is incorporated herein by reference.

### BACKGROUND ART

Patent Document 1 discloses a bonding method in which a positive electrode plate and a negative electrode plate are stacked via a separator to form an electrode plate group spirally wound, and a collector plate is bonded by laser welding to each of a protruding portion of a positive electrode collector protruding at one end in a spiral central axis direction of the electrode plate group and a protruding portion of a negative electrode collector protruding at the other end. In Patent Document 1, by pressing the one end of the electrode plate group in the spiral central axis direction, the protruding portion of the positive electrode collector at the one end in the spiral central axis direction and the protruding portion of the negative electrode collector at the other end are bent in a radial direction of the spiral to form flat portions. Furthermore, in Patent Document 1, when the collector plate on a positive electrode side and the collector plate on a negative electrode side are pressed in parallel with the flat portions, irradiation with laser is performed from an outer surface of the collector plate on an outer side of the spiral central axis direction to laser-weld the protruding portion of the positive electrode collector and the collector plate and laser-welds the protruding portion of the negative electrode collector and the collector plate.

### CITATION LIST

### Patent Document

### [Patent Document 1]

Japanese Unexamined Patent Application, First Publication No. 2011-129328

### SUMMARY OF INVENTION

### Technical Problem

In a bonding method as in Patent Document 1, when the output of a laser is too low, a sufficient welding strength cannot be ensured, and welding defects may occur. On the other hand, when the output of the laser is too high, spatter from the collector plate and melting of the separator due to heat may occur, which may cause an internal micro-short circuit or defective self-discharge.

An object of the present disclosure is to provide a bonding method and a power storage device capable of suppressing spatter and separator melting while maintaining a welding strength.

### Solution to Problem

According to one aspect of the present disclosure, a bonding method includes a step of alternately stacking an electrode foil and a separator and forming a protruding portion extending to extend the stacked electrode foil, and a step of wobbling welding the protruding portion and a collector plate by irradiating an outer surface of the collector plate with laser light in a state in which an inner surface of the collector plate is in contact with the protruding portion.

### Advantageous Effects of Invention

According to the above aspect, it is possible to suppress spatter and separator melting while maintaining welding strength.

### BRIEF DESCRIPTION OF DRAWINGS

FIG. 1 is a cross-sectional view showing a schematic configuration of a power storage device according to an embodiment of the present disclosure.

FIG. 2 is a plan view of a stacked body in which an element is deployed according to the embodiment of the present disclosure.

FIG. 3 is a cross-sectional view of the stacked body of FIG. 2.

FIG. 4 is a side view showing a state in which the stacked body of FIG. 2 is spirally wound.

FIG. 5 is a cross-sectional view of a vicinity of a bonded portion between a negative electrode protruding portion and a negative electrode collector plate according to the embodiment of the present disclosure.

FIG. 6 is a plan view showing a wobbling weld mark of the collector plate according to the embodiment of the present disclosure.

FIG. 7 is an enlarged view of the wobbling weld mark.

FIG. 8 is a flowchart of a bonding method according to the embodiment of the present disclosure.

FIG. 9 is a cross-sectional view of the element according to the embodiment of the present disclosure along a central axis a.

FIG. 10 is a side view showing a step of forming a flat portion according to the embodiment of the present disclosure.

FIG. 11 is a graph showing a transition of an output of laser light (vertical axis) with respect to a welding position (horizontal axis) in wobbling welding according to the embodiment of the present disclosure.

FIG. 12 is a cross-sectional view corresponding to FIG. 5 according to a first modification example of the embodiment of the present disclosure.

FIG. 13 is a plan view corresponding to FIG. 6 according to a second modification example of the embodiment of the present disclosure.

### DESCRIPTION OF EMBODIMENTS

### Embodiment

### <<Configuration of Power Storage Device>>

Hereinafter, an embodiment of the present invention will be described in detail with reference to the drawings.

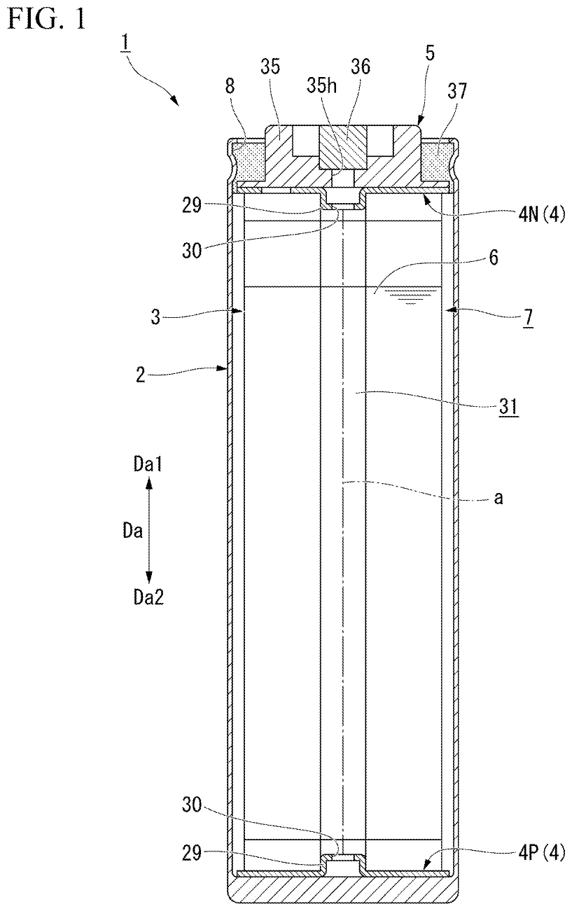

As shown in FIG. 1, a lithium ion capacitor (LIC) will be described as an example of a power storage device 1 according to the present embodiment. That is, the power storage device 1 of the present embodiment has a structure including an electric double-layer capacitor in a positive electrode and a lithium-ion battery in a negative electrode.

The power storage device 1 includes a casing 2, an element 3, a collector plate 4, a terminal plate 5, and an electrolytic solution 6.

The casing 2 is made of a metal such as an aluminum alloy and has a bottomed tubular shape. The casing 2 forms an accommodation space 7 that accommodates the element 3, the collector plate 4, and the electrolytic solution 6. A terminal plate 5 is attached to an opening portion 8 of the casing 2 of the present embodiment by drawing or the like, and the opening portion 8 is closed by the terminal plate 5.

As shown in FIGS. 1 to 4, the element 3 includes a plurality of electrode foils 9, a plurality of separators 10, and a plurality of protruding portions 11. The element 3 of the present embodiment is formed in a cylindrical shape that can be accommodated in the accommodation space 7 of the casing 2. The element 3 formed in a cylindrical shape is accommodated in the accommodation space 7 together with the electrolytic solution 6. A central axis a (see FIG. 1) of the element 3 extends along a central axis of the accommodation space 7 of the casing 2 in a state in which the element 3 is accommodated in the accommodation space 7 of the casing 2.

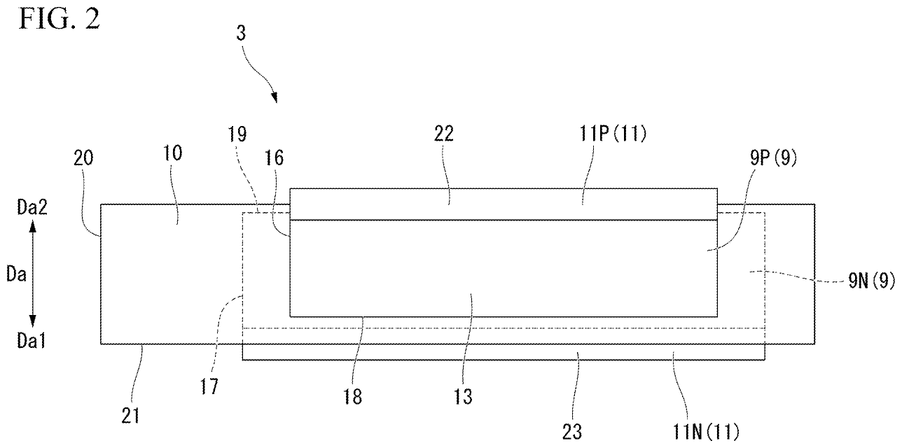

As shown in FIG. 2, the element 3 of the present embodiment includes a positive electrode foil 9P and a negative electrode foil 9N as the electrode foils 9 and includes a positive electrode protruding portion 11P and a negative electrode protruding portion 11N as the protruding portions 11. In the following description, a direction in which the central axis a (see FIG. 1) of the element 3 extends is referred to as a central axis direction Da, a side where the opening portion 8 of the casing 2 is disposed in the central axis direction Da is referred to as a first side Da1 along the central axis, and the opposite side thereof is referred to as the second side Da2 along the central axis.

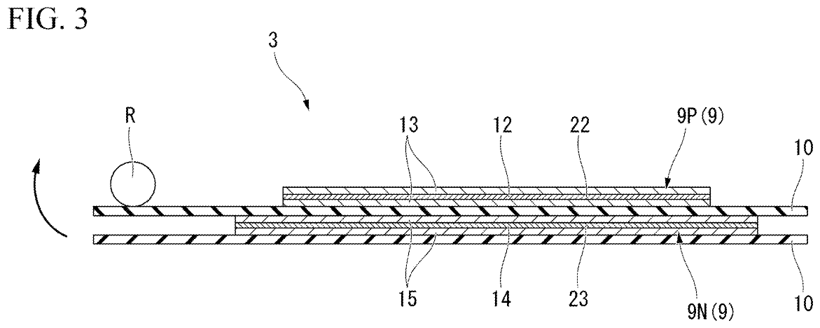

As shown in FIG. 3, the positive electrode foil 9P of the present embodiment includes an aluminum layer 12 formed of an aluminum alloy, and positive electrode carbon material layers 13 formed by coating front and back surfaces of the aluminum layer 12 with a carbon material. The negative electrode foil 9N of the present embodiment includes a copper layer 14 formed of copper, which is a metal having a melting point of 1000° C. or higher, and negative electrode carbon material layers 15 formed by coating front and back surfaces of the copper layer 14 with a carbon material. The aluminum layer 12 and the copper layer 14 have a thickness of, for example, 6 to 20 μm. The positive electrode foil 9P and the negative electrode foil 9N of the present embodiment each have a rectangular shape in a plan view in a deployed state shown in FIG. 2, and short sides 16 and 17 of the rectangular shape extend in the central axis direction Da. In the present embodiment, a case is illustrated where a length of a long side 18 of the positive electrode foil 9P is smaller than a length of a long side 19 of the negative electrode foil 9N, and a length of the short side 16 of the positive electrode foil 9P is equivalent to (specifically, slightly smaller than) a length of the short side 17 of the negative electrode foil 9N.

The separator 10 is made of an electrically insulating material that maintains electrical insulation at least between electrodes of the power storage device 1 and has a sheet shape. The separator 10 is disposed between the positive electrode foil 9P and the negative electrode foil 9N. The separators 10 of the present embodiment are disposed to sandwich the negative electrode foil 9N. The separator 10 of the present embodiment has a rectangular shape in a plan view in a deployed state shown in FIG. 2, and a short side 20 of the rectangular shape extends in the central axis direction Da. The length of a long side 21 of the separator 10 is larger than the length of the long side 18 of the positive electrode foil 9P and the length of the long side 19 of the negative electrode foil 9N. Furthermore, the length of the short side 20 of the separator 10 is larger than the length of the short side 16 of the positive electrode foil 9P or the length of the short side 17 of the negative electrode foil 9N. The separator 10 has a thickness of, for example, 18 to 22 μm.

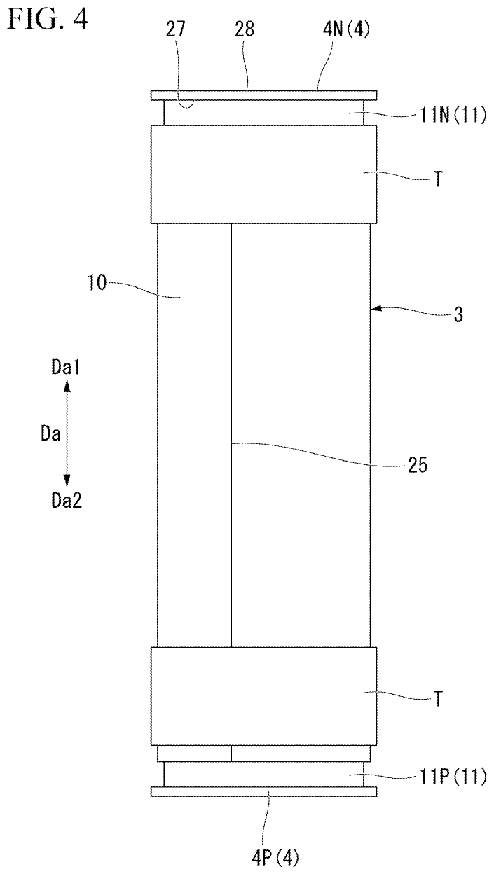

The protruding portion 11 is formed integrally with the electrode foil 9 and extends in a direction in which the electrode foil 9 extends. As shown in FIGS. 2 and 4, the element 3 of the present embodiment includes the negative electrode protruding portion 11N on the first side Da1 along the central axis and the positive electrode protruding portion 11P on the second side Da2 along the central axis as the plurality of protruding portions 11.

The positive electrode protruding portion 11P extends in a direction in which the positive electrode foil 9P extends and protrudes from the separator 10 to the second side Da2 along the central axis. In the element 3 in the present embodiment, for example, a positive electrode sheet 22 made of an aluminum alloy in which the aluminum layer 12 of the positive electrode foil 9P and the positive electrode protruding portion 11P are integrally formed is disposed to be shifted to the second side Da2 along the central axis with respect to the separator 10 so that the positive electrode protruding portion 11P protrudes to the second side Da2 along the central axis.

The negative electrode protruding portion 11N extends in a direction in which the negative electrode foil 9N extends and protrudes from the separator 10 to the first side Da1 along the central axis. A negative electrode sheet 23 made of copper in which the copper layer 14 of the negative electrode foil 9N and the negative electrode protruding portion 11N are integrally formed is disposed to be shifted to the first side Da1 along the central axis with respect to the separator 10 so that the negative electrode protruding portion 11N protrudes to the first side Da1 along the central axis.

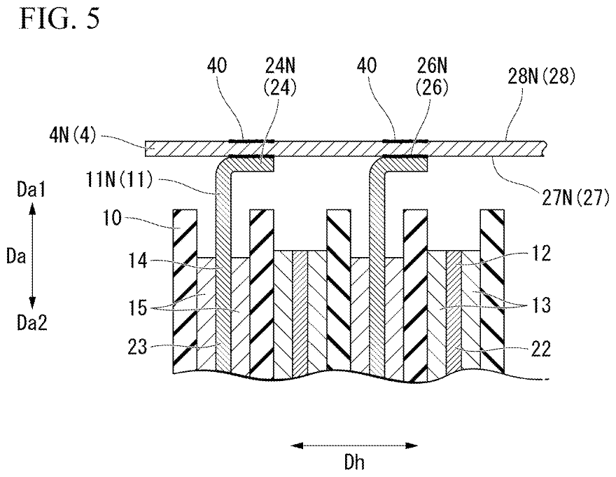

As shown in FIG. 5, the negative electrode protruding portion 11N of the present embodiment includes a flat portion 24N on an edge portion thereof on the first side Da1 along the central axis. The flat portion 24N extends in a first direction Dh, which intersects the central axis direction Da, in other words, a direction intersecting the negative electrode foil 9N. Although not shown, the positive electrode protruding portion 11P also includes a flat portion 24 on an edge portion thereof on the second side Da2 along the central axis, similarly to the negative electrode protruding portion 11N. The flat portion 24P of the positive electrode protruding portion 11P also extends in the first direction Dh, which is a direction intersecting the central axis direction Da, in other words, a direction intersecting the positive electrode foil 9P. FIG. 5 schematically shows the flat portions 24N, and extending angles of the flat portions 24N of the negative electrode protruding portions 11N with respect to the negative electrode foil 9N are all the same angle. However, in the actual negative electrode protruding portions 11N, the angles of the flat portions 24N may not be constant over the entire region for manufacturing reasons, for example, and may have irregularities when viewed from the central axis direction Da.

As shown in FIG. 3, the element 3 is formed in a spiral shape around the central axis a by, for example, being wound around a cylindrical roller R in a state in which the plurality of electrode foils 9 and the plurality of separators 10 are stacked. That is, the positive electrode foil 9P, the negative electrode foil 9N, the separator 10, the positive electrode protruding portion 11P, and the negative electrode protruding portion 11N that constitute the element 3 each have a spiral shape when viewed from the central axis direction Da. As shown in FIG. 4, the cylindrical element 3 thus formed includes the separator 10 on an outer peripheral surface thereof. In the present embodiment, an adhesive tape T or the like is wound around each of an edge portion of the outer peripheral surface on the first side Da1 along the central axis and an edge portion of the outer peripheral surface on the second side Da2 along the central axis, such that an end portion 25 of the separator 10 does not expand radially outward about the central axis a.

As shown in FIG. 5, a negative electrode collector plate 4N is fixed to the negative electrode protruding portion 11N via a welded portion 26N. The same applies to a positive electrode collector plate 4P. As shown in FIG. 4, in the present embodiment, two collector plates 4 of the positive electrode collector plate 4P and the negative electrode collector plate 4N are provided as a plurality of the collector plates 4. The positive electrode collector plate 4P and the negative electrode collector plate 4N are formed in a substantially flat plate shape having a circular outer edge about the central axis a, and have an inner surface 27 facing the protruding portion 11 side in the central axis direction Da and an outer surface 28 facing a side opposite to the inner surface 27 to be back to back in the central axis direction Da.

The positive electrode collector plate 4P is formed of a metal containing the same metal as the positive electrode protruding portion 11P. That is, the positive electrode collector plate 4P of the present embodiment is formed of an aluminum alloy. The negative electrode collector plate 4N is formed of a metal containing the same metal as the negative electrode protruding portion 11N. The negative electrode collector plate 4N is formed of a material having a melting point of 1000° C. or higher. The negative electrode collector plate 4N of the present embodiment is made of copper. As shown in FIG. 1, a projection portion 29 that protrudes toward the protruding portion 11 side in the central axis direction Da is formed in a central portion of the collector plate 4 in the present embodiment. Furthermore, a through hole 30 is formed in the projection portion 29 of the collector plate 4. The projection portion 29 is inserted into a cavity portion 31 having a circular cross section which is formed in a central portion of the element 3 and extends in the central axis direction Da.

As shown in FIG. 5, an inner surface 27N of the negative electrode collector plate 4N is fixed to the flat portion 24N of the negative electrode protruding portion 11N via the welded portion 26N. On an outer surface 28N of the negative electrode collector plate 4N, a wobbling weld mark 40 is formed at a position corresponding to the welded portion 26N formed on the inner surface 27N side. In other words, the inner surface 27N of the negative electrode collector plate 4N is fixed to the flat portion 24N via the welded portion 26N formed on the outer surface 28N of the negative electrode collector plate 4N by wobbling welding in which irradiation with laser light is performed. The same applies to a positive electrode collector plate 4P.

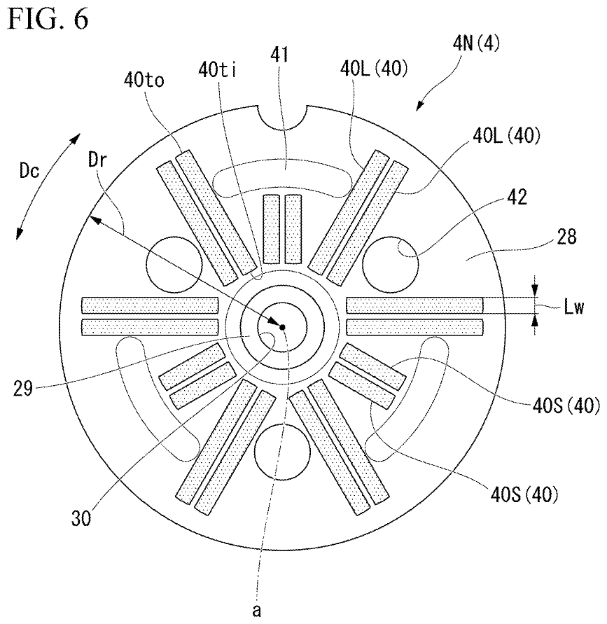

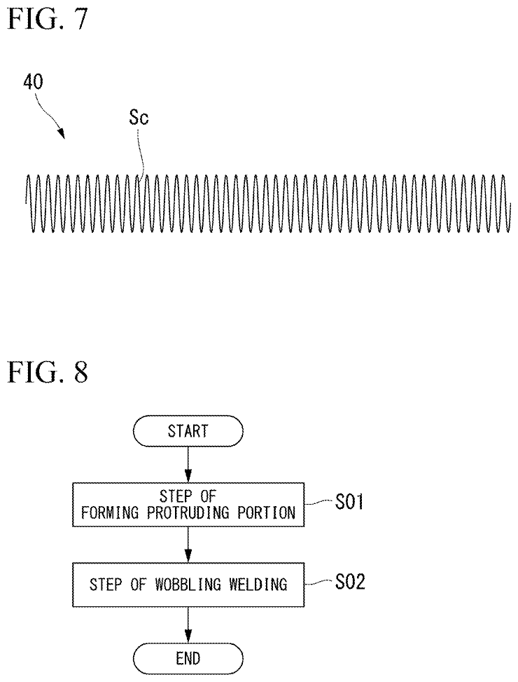

As shown in FIGS. 6 and 7, a plurality of the wobbling weld marks 40 are provided. The wobbling weld marks 40 of the present embodiment are formed by wobbling welding in which a radial direction (in other words, a radially outward direction) Dr about the central axis a is a welding proceeding direction. Here, the welding proceeding direction is a direction from a welding start point at which wobbling welding starts toward a welding end point at which wobbling welding ends.

In the present embodiment, two wobbling weld marks 40 extending in parallel with each other form a set, and a plurality of sets of the wobbling weld marks 40 are provided at intervals in a circumferential direction Dc about the central axis a. The plurality of wobbling weld marks 40 each include a sine curve-shaped weld mark Sc (see FIG. 7) having an amplitude in a direction intersecting a welding proceeding direction. A width Lw of the wobbling weld mark 40 in a direction (in other words, the circumferential direction Dc) intersecting the welding proceeding direction (in other words, the radial direction Dr) in the present embodiment is, for example, 0.4 to 0.8 mm, and a thickness of the sine curve-shaped weld mark Sc is about 100 to 200 μm. Further, the sine curve-shaped weld marks Sc have 20 to 30 cycles per unit distance (10 mm).

In the present embodiment, as the wobbling weld marks 40, a plurality of first wobbling weld marks 40L and a plurality of second wobbling weld marks 40S having a shorter length in a welding proceeding direction than the first wobbling weld marks 40L are provided. As an exemplary example in the present embodiment, six sets of the first wobbling weld marks 40L are provided at equal intervals in the circumferential direction Dc, and three sets of the second wobbling weld marks 40S are provided at equal intervals in the circumferential direction Dc.

When viewed from the central axis direction Da, an outer end portion 40to of the first wobbling weld mark 40L in the radial direction Dr of the collector plate 4 is located slightly on an outer peripheral side from a position of the protruding portion 11 disposed on the outermost peripheral side. Furthermore, as viewed from the central axis direction Da, an inner end portion 40ti of the first wobbling weld mark 40L in the radial direction Dr of the collector plate 4 is located slightly on an inner periphery side from a position of the protruding portion 11 disposed on the innermost periphery side. In addition, in the collector plate 4 illustrated in the present embodiment, a groove portion 41 extending in the circumferential direction Dc is formed at a position on an outer side in the radial direction Dr between the first wobbling weld marks 40L adjacent to each other in the circumferential direction De to ensure rigidity. Further, a case is illustrated where a circular hole 42 is formed at a location where the second wobbling weld mark 40S is not formed between the first wobbling weld marks 40L in the circumferential direction Dc.

The second wobbling weld mark 40S in the present embodiment is formed only on an inner side in the radial direction Dr from the groove portion 41. The second wobbling weld mark 40S of the present embodiment has a length approximately ½ of that of the first wobbling weld mark 40L. The welded portion 26 described above is formed by irradiating the outer surface 28 with the laser light for wobbling welding so that part of the inner surface 27 of the collector plate 4 located on a side opposite to a laser light irradiation position and part of the collector plate 4 irradiated with the laser light are melted and solidified.

As shown in FIG. 1, the terminal plate 5 closes the opening portion 8 of the casing 2. The terminal plate 5 of the present embodiment includes at least a terminal plate body 35, a pressure regulating valve 36, and a sealing rubber 37. The terminal plate body 35 has a circular shape when viewed from the central axis direction Da and has a hole 35h in a central portion thereof. The pressure regulating valve 36 is disposed in the central portion of the terminal plate body 35 and regulates pressure in the accommodation space 7 through the hole 35h. The sealing rubber 37 seals a gap between the terminal plate body 35 and an inner peripheral surface of the opening portion 8 of the casing 2. The pressure regulating valve 36 is attached to close the hole 35h after the electrolytic solution 6 is injected into the accommodation space 7 through the hole 35h of the terminal plate body 35.

### <<Bonding Method>>

The power storage device 1 of the present embodiment has the above-described configuration. Next, among assembly methods for assembling the power storage device 1, particularly, a bonding method between the element 3 and the terminal plate 5 will be described with reference to the drawings.

As shown in FIG. 8, the bonding method of the present embodiment includes a step of forming the protruding portion (step S01) and a step of wobbling welding (step S02).

In the step of forming the protruding portion (step S01), as shown in FIG. 2, the electrode foil 9 and the separator 10 are alternately stacked, and the protruding portion 11 which extends to extend the stacked electrode foil 9 is formed. In the present embodiment, as described above, the positive electrode sheet 22 in which the aluminum layer 12 of the positive electrode foil 9P and the positive electrode protruding portion 11P are integrally formed is disposed to be shifted to the second side Da2 along the central axis with respect to the separator 10 to form the positive electrode protruding portion 11P protruding to the second side Da2 along the central axis. In addition, the negative electrode sheet 23 in which the copper layer 14 of the negative electrode foil 9N and the negative electrode protruding portion 11N are integrally formed is disposed to be shifted to the first side Da1 along the central axis with respect to the separator 10 to form the negative electrode protruding portion 11N protruding to the first side Da1 along the central axis.

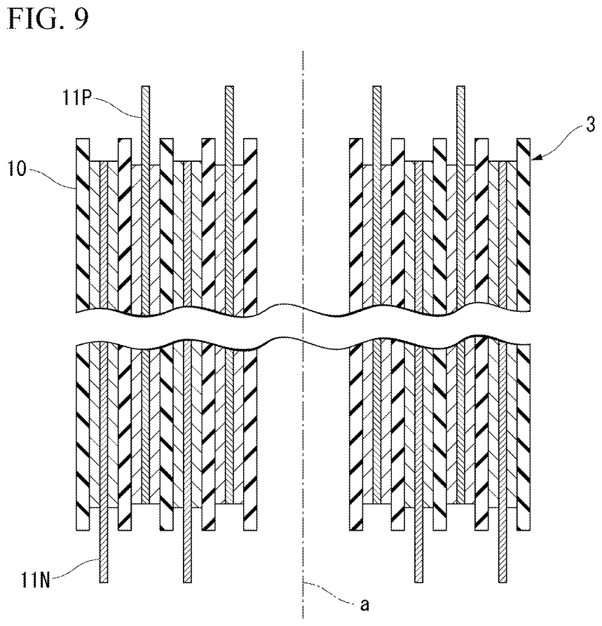

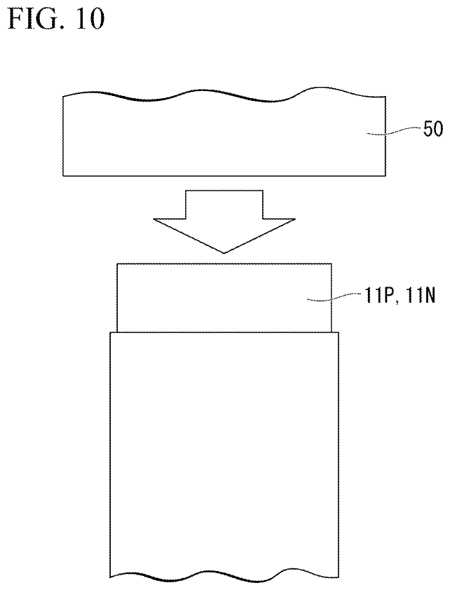

In the step of forming the protruding portion (step S01), further, the stacked body is wound spirally in a direction of an arrow shown in FIG. 3 to form a cylindrical shape, and the adhesive tapes T are wound around both end portions of the separator 10 in the central axis direction Da exposed on an outer peripheral surface of the cylindrical shape. In the step of forming the protruding portion (step S01), further, as shown in FIG. 9, a pressing jig 50 is pressed against the positive electrode protruding portion 11P and the negative electrode protruding portion 11N of the element 3 formed in a cylindrical shape from the central axis direction Da as shown in FIG. 10 to bend the edge portion of the positive electrode protruding portion 11P in the first direction intersecting the positive electrode foil 9P and bend the edge portion of the negative electrode protruding portion 11N in the first direction intersecting the negative electrode foil 9N to form flat portions 24N and 24P (not shown) in the positive electrode protruding portion 11P and the negative electrode protruding portion 11N, respectively.

In the step of wobbling welding (step S02), the protruding portion 11 and the collector plate 4 are bonded by wobbling welding. More specifically, in the step of wobbling welding (step S02), as shown in FIG. 5, the negative electrode collector plate 4N is positioned parallel to the flat portion 24N of the negative electrode protruding portion 11N, and the inner surface 27N of the negative electrode collector plate 4N is brought into contact with the flat portion 24N of the negative electrode protruding portion 11N. Then, the outer surface 28N of the negative electrode collector plate 4N is irradiated with laser light to perform wobbling welding. Similarly, in the step of wobbling welding (step S02), the positive electrode collector plate 4P (not shown) is positioned parallel to the flat portion 24P (not shown) of the positive electrode protruding portion 11P (not shown), and an inner surface 27P of the positive electrode collector plate 4P is brought into contact with the flat portion 24P of the positive electrode protruding portion 11P. Then, the outer surface 28N of the positive electrode collector plate 4P is irradiated with laser light to perform wobbling welding. Here, in the wobbling welding, as shown in FIG. 7, irradiation with laser light is performed to draw a sine curve having an amplitude in a direction intersecting the welding proceeding direction described above. As described above, the irradiation with the laser light is performed a plurality of times in the radial direction Dr on each of an outer surface 28P of the positive electrode collector plate 4P and the outer surface 28N of the negative electrode collector plate 4N. In the present embodiment, the wobbling welding is performed such that the above-described first wobbling weld mark 40L and second wobbling weld mark 40S are formed.

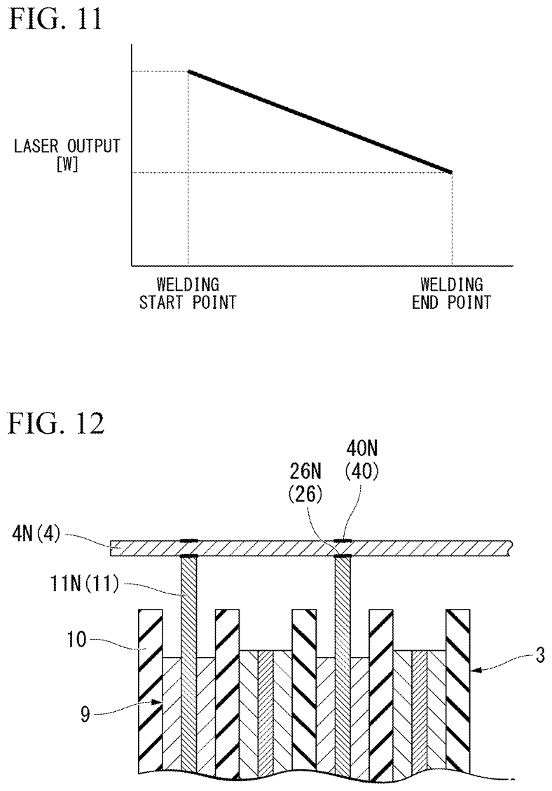

In the step of wobbling welding (step S02), further, the output of the laser light is gradually decreased from the welding start point toward the welding end point of the wobbling welding. In the present embodiment, as shown in FIG. 11, the output of the laser light is linearly and gradually decreased from the welding start point toward the welding end point of the wobbling welding. That is, in the wobbling welding of the present embodiment, a rate of decrease in the output of the laser light with respect to a welding distance is constant. The decrease in the output of the laser light with respect to the welding distance is not limited to a case of a linear transition, and may be a curved transition, for example. As an example of the laser output at the welding start point and the welding end point, a case where the laser output at the welding start point is 800 W and the laser output at the welding end point is 700 W can be illustrated. In addition, as another example, a case where the laser output at the welding start point is 750 W and the laser output at the welding end point is 600 W can be illustrated.

A structure in which the protruding portion 11 and the collector plate 4 are bonded by the above-described bonding method is accommodated in the casing 2 after the terminal plate body 35 is welded to the collector plate 4. Thereafter, the opening portion 8 of the casing 2 is closed by the sealing rubber 37 of the terminal plate 5, the electrolytic solution 6 is injected through the hole 35h of the terminal plate body 35, and the pressure regulating valve 36 is attached.

### <<Operation and Effect>>

As described above, in the present embodiment, in a state in which the inner surface 27 of the collector plate 4 is in contact with the protruding portion 11, the outer surface 28 of the collector plate 4 is irradiated with laser light to cause the protruding portion 11 and the collector plate 4 to be wobbling welded. In a case where the protruding portion 11 and the collector plate 4 are bonded by wobbling welding in this way, a welding area can be secured and heat input by welding can be stabilized, compared with a case where irradiation with laser light is performed linearly in the welding proceeding direction. Therefore, it is possible to suppress an insufficient welding strength between the protruding portion 11 and the collector plate 4 due to a decrease in an amount of heat input to the collector plate 4. Furthermore, by stabilizing the heat input due to welding by wobbling welding, it is possible to suppress spatter and the separator 10 melting due to an excessive increase in the amount of heat input to the collector plate 4. Therefore, it is possible to suppress the occurrence of a short circuit between the positive electrode foil 9P and the negative electrode foil 9N and defective self-discharge due to a micro-short circuit between the positive electrode foil 9P and the negative electrode foil 9N.

According to the bonding method of the present embodiment, since melting of the separator 10 can be suppressed by wobbling welding, a distance between the electrode foil 9 and the collector plate 4 can be shortened. Therefore, in a case where the size of the casing 2 is constant, an area of a stacked portion between the electrode foil 9 and the separator 10 can be made wider, so that a larger capacity of the power storage device 1 can be ensured.

In the present embodiment, further, the flat portion 24 is formed in the protruding portion 11, and the collector plate 4 is wobbling welded to the flat portion 24. In this case, since a contact area between the protruding portion 11 and the collector plate 4 can be increased, the welding strength can be obtained more easily.

The negative electrode protruding portion 11N and the negative electrode collector plate 4N of the present embodiment are formed of copper, which is a metal having a melting point of 1000° C. or higher and a high reflectance of laser light. When laser welding is performed linearly on such a metal having a melting point of 1000° C. or higher, heat input may not be stable, and sufficient welding strength may not be obtained. However, in the bonding method of the present embodiment, since the negative electrode protruding portion 11N and the negative electrode collector plate 4N are welded by wobbling welding, an excessive amount of heat input to the negative electrode collector plate 4N by laser welding can be suppressed, and stable welding can be performed.

In the present embodiment, the output of the laser light is gradually decreased from the welding start point toward the welding end point. In this case, in an initial stage of welding in which heat is not input to the collector plate 4, heat can be quickly input by a relatively high laser output. In addition, since the laser output can be gradually decreased as the heat input to the collector plate 4 progresses, it is possible to suppress an excessive heat input to the collector plate 4. Therefore, it is possible to further suppress spatter and the separator 10 melting.

In the present embodiment, the output of the laser light is gradually and linearly decreased. Therefore, wobbling welding can be easily performed without complicating the output control of the laser light.

In the present embodiment, wobbling welding is performed by irradiating with laser light in a sine curve shape having an amplitude in a direction intersecting the welding proceeding direction. In this case, irradiation trajectories of the laser light (in other words, sine curve-shaped weld marks Sc) do not intersect or form a corner portion. Therefore, it is possible to prevent the heat input due to the laser light irradiation from concentrating on a specific location.

In the present embodiment, in a case where a thickness of each of the aluminum layer 12 and the copper layer 14 of the electrode foil 9 is 6 to 20 μm and a thickness of the collector plate 4 is 0.3 to 1.0 mm, the electrode foil 9 and the collector plate 4 are bonded by wobbling welding. Therefore, even in a case where the thickness of each of the aluminum layer 12 and the copper layer 14 of the electrode foil 9 is extremely small relative to the thickness of the collector plate 4, the required welding strength can be ensured to improve the reliability of the power storage device 1.

### Other Embodiments

Hereinabove, the embodiment has been described in detail with reference to the drawings; however, the specific configurations are not limited to the above-described configurations, and various design changes or the like can be made.

In the above-described embodiment, a case of forming the wobbling weld mark 40 including the sine curve-shaped weld mark Sc has been described. However, the wobbling weld mark 40 is not limited to a case where the sine curve-shaped weld mark Sc is included. The weld mark included in the wobbling weld mark 40 may have, for example, a circular shape or a shape such as a FIG. 8 of the Arabic numeral. In addition, the weld mark may be a combination of a plurality of shapes that can be used in wobbling welding, such as a sine curve, a circular shape, and a FIG. 8 of the Arabic numeral.

In the above-described embodiment, a case where the positive electrode protruding portion 11P and the positive electrode collector plate 4P are wobbling welded and the negative electrode protruding portion 11N and the negative electrode collector plate 4N are wobbling welded has been described. However, for example, the positive electrode protruding portion 11P and the positive electrode collector plate 4P may be bonded by other welding other than wobbling welding and the negative electrode protruding portion 11N and the negative electrode collector plate 4N may be bonded by wobbling welding.

In the above-described embodiment, a case where the negative electrode protruding portion 11N and the negative electrode collector plate 4N are formed of copper has been described. However, the negative electrode protruding portion 11N and the negative electrode collector plate 4N are not limited to copper and can be any material having a melting point of 1000° C. or higher. Furthermore, although a case where the positive electrode protruding portion 11P and the positive electrode collector plate 4P are formed of an aluminum alloy has been described, they may be formed of, for example, a material having a melting point of 1000° C. or higher, such as copper.

In the above-described embodiment, a case where the flat portion 24 is formed on the protruding portion 11 has been described. However, for example, as in a first modification example shown in FIG. 12, the flat portion 24 of the protruding portion 11 may be omitted, and the inner surface 27 of the collector plate 4 may be abutted against the edge portion of the protruding portion 11 extending in the central axis direction Da to fix the protruding portion 11 to the collector plate 4 via the welded portion 26.

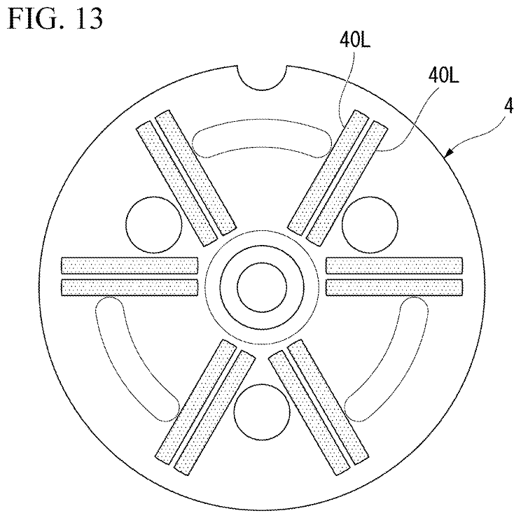

In the above-described embodiment, a case where the first wobbling weld mark 40L and the second wobbling weld mark 40S are formed on the outer surface 28 of the collector plate 4 has been described. However, for example, as in a second modification example shown in FIG. 13, the second wobbling weld mark 40S may be omitted, and only the first wobbling weld mark 40L may be provided. Further, a length of the wobbling weld mark 40 in the radial direction Dr is not limited to the length in the above-described embodiment, and may be changed as appropriate.

In the above-described embodiment, a case where the plurality of electrode foils 9 and the plurality of separators 10 are stacked alternately and then wound in a spiral shape to form the element 3 in a cylindrical shape has been described. However, the bonding method of the present disclosure is applicable to the element 3 not wound in a spiral shape.

In the above-described embodiment, the lithium ion capacitor has been described as an example of the power storage device 1, but other capacitors or secondary batteries different from the lithium ion capacitor may be used.

### INDUSTRIAL APPLICABILITY

According to the above aspect, it is possible to suppress an occurrence of spatter and melting of a separator while maintaining a welding strength.

### REFERENCE SIGNS LIST

1: Power storage device
2: Casing
3: Element
4: Collector plate
5: Terminal plate
6: Electrolytic solution
7: Accommodation space
8: Opening portion
9: Electrode foil
9P: Positive electrode foil
9N: Negative electrode foil
10: Separator
11: Protruding portion
11P: Positive electrode protruding portion
11N: Negative electrode protruding portion
12: Aluminum layer
13: Positive electrode carbon material layer
14: Copper layer
15: Negative electrode carbon material layer
16, 17, 20: Short side
18, 19, 21: Long side
22: Positive electrode sheet
23: Negative electrode sheet
24: Flat portion
25: End portion
26: Welded portion
27: Inner surface
28: Outer surface
29: Projection portion
30: Through hole
31: Cavity portion
35: Terminal plate body
36: Pressure regulating valve
37: Sealing rubber
40: Wobbling weld mark
41: Groove portion
R: Roller
T: Adhesive tape
Sc: Weld mark

1. A bonding method comprising:
a step of alternately stacking an electrode foil and a separator and forming a protruding portion extending to extend the stacked electrode foil; and
a step of wobbling welding the protruding portion and a collector plate by irradiating an outer surface of the collector plate with laser light in a state in which an inner surface of the collector plate is in contact with the protruding portion.

2. The bonding method according to claim 1, wherein in the step of forming the protruding portion, at least part of the protruding portion is bent in a first direction intersecting the electrode foil to form a flat portion extending in the first direction, and
in the step of wobbling welding, the wobbling welding is performed in a state in which the inner surface of the collector plate is in contact with the flat portion.

3. The bonding method according to claim 1, wherein in the step of wobbling welding, the protruding portion and the collector plate, which are made of a material having a melting point of 1000° C. or higher, are subjected to the wobbling welding.

4. The bonding method according to claim 1, wherein in the step of wobbling welding, an output of the laser light is gradually decreased from a welding start point to a welding end point in the wobbling welding.

5. The bonding method according to claim 4, wherein the output of the laser light is linearly decreased.

6. The bonding method according to claim 1, wherein a thickness of a metal foil included in the electrode foil is 6 to 20 μm, and a thickness of the collector plate is 0.3 to 1.0 mm.

7. The bonding method according to claim 1, wherein in the step of wobbling welding, the wobbling welding is performed by irradiation with the laser light in a sine curve shape having an amplitude in a direction intersecting a welding proceeding direction.

8. A power storage device comprising:
a stacked portion including an electrode foil and a separator that are alternately stacked;
a protruding portion formed integrally with the electrode foil and extending in a direction in which the electrode foil extends; and
a collector plate including an inner surface fixed to the protruding portion via a welded portion,
wherein the collector plate has a wobbling weld mark at a position corresponding to the welded portion in an outer surface facing a side opposite to the inner surface.

9. The power storage device according to claim 8, wherein the protruding portion includes a flat portion extending in a first direction intersecting the electrode foil, and
the inner surface of the collector plate is fixed to the flat portion via the welded portion.

10. The power storage device according to claim 8, wherein the electrode foil and the collector plate are materials having a melting point of 1000° C. or higher.

11. The power storage device according to claim 8, wherein a thickness of a metal foil included in the electrode foil is 6 to 20 μm, and a thickness of the collector plate is 0.3 to 1.0 mm.

12. The power storage device according to claim 8, wherein the wobbling weld mark includes a weld mark having a sine curve shape with an amplitude in a direction intersecting a welding proceeding direction of the wobbling weld mark.
